(19) United States
(12) Patent Application Publication
(10) Pub. No.: US 2014/0320060 A1
(43) Pub. Date: Oct. 30, 2014

(54) VEHICLE HAVING WIND-POWERED GENERATOR

(71) Applicant: Aleksander Hrnjak, Windsor (CA)

(72) Inventor: Aleksander Hrnjak, Windsor (CA)

(21) Appl. No.: 13/869,064

(22) Filed: Apr. 24, 2013

(51) Int. Cl. H02J 7/14

(52) U.S. Cl. CPC H02J 7/1415
USPC 320/101

(57) ABSTRACT

A vehicle may include a battery, a generator, a turbine and a movable member. The generator may be in communication with the battery and may be operable to charge the battery. The turbine may be mounted within a cavity formed in a body of the vehicle and may be rotatable relative to the body. The turbine may be coupled to the generator to transmit torque from the turbine to the generator. The cavity may include an inlet and an outlet. The member may be movable relative to the cavity between an open position allowing airflow through the inlet and a closed position restricting airflow through the inlet.

### FIELD

The present disclosure relates to a wind-powered generator for a vehicle.

### BACKGROUND

Vehicles typically include one or more batteries for powering various vehicle systems and accessories. Conventionally, such vehicles may include an alternator powered by an internal combustion engine of the vehicle that is operable to recharge the battery. Some vehicles include a regenerative-braking system that converts the vehicle's kinetic energy into electrical energy to recharge one or more vehicle batteries.

### SUMMARY

The present disclosure provides a vehicle that may include a battery, a generator, a turbine and a movable member. The generator may be in communication with the battery and may be operable to charge the battery. The turbine may be mounted within a cavity formed in a body of the vehicle and may be rotatable relative to the body. The turbine may be coupled to the generator to transmit torque from the turbine to the generator. The cavity may include an inlet and an outlet. The member may be movable relative to the cavity between an open position allowing airflow through the inlet and a closed position restricting airflow through the inlet.

In some embodiments, the cavity may be formed in a roof of the body.

In some embodiments, the member may be substantially flush with a roof of the body when the member is in the closed position and may extend outward from the roof in the open position.

In some embodiments, the turbine may be disposed entirely below a top surface of a roof of the body.

In some embodiments, the vehicle may include an actuator operable to move the member between the open and closed positions and a control module controlling operation of the actuator in response to deceleration of the vehicle.

In some embodiments, the control module may control operation of the actuator based on whether the vehicle is in a highway-driving mode or a city-driving mode.

In some embodiments, the vehicle may include a clutch coupled to the turbine and the generator and operable in an engaged mode in which rotational motion of the turbine is transmitted to the generator and a disengaged mode in which the turbine is allowed to rotate independently of the generator.

In some embodiments, the vehicle may include a control module controlling operation of the clutch in response to deceleration of the vehicle.

In some embodiments, the cavity may be formed in a lateral side of the body.

In some embodiments, the vehicle may include another turbine coupled to another generator and mounted within another cavity formed in the body of the vehicle.

In another form, the present disclosure provides a generator system for a vehicle that may include a generator, a wind-powered turbine, and a clutch. The generator may be in communication with a vehicle battery and operable to charge the vehicle battery. The turbine may be rotatably in response to exposure to airflow. The clutch may be coupled to the turbine and the generator and may be operable in an engaged mode to transmit torque from the turbine to the generator and a disengaged mode in which the turbine is allowed to rotate independently of the generator.

In some embodiments, the generator system may include a control module controlling operation of the clutch in response to deceleration of the vehicle. In some embodiments, the control module may control operation of the clutch based on whether the vehicle is in a highway-driving mode or a city-driving mode.

In some embodiments, the generator system may include a scoop extending from a body of the vehicle that directs air toward the turbine.

In some embodiments, the turbine may be mounted within a cavity formed in a body of the vehicle and rotatable relative to the body.

In some embodiments, the generator system may include a member movable relative to the cavity between an open position allowing airflow through an inlet of the cavity and a closed position restricting airflow through the inlet.

In some embodiments, the member may be substantially flush with the roof when the member is in the closed position and may extend outward from the roof in the open position.

In some embodiments, the generator system may include an actuator operable to move the member between the open and closed positions and a control module controlling operation of the actuator in response to deceleration of the vehicle.

In some embodiments, the turbine may be disposed below a top surface of a roof of the vehicle.

In some embodiments, the turbine may rotate about an axis that is perpendicular to an axis extending through front and rear ends of a body of the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a top view of a vehicle including a generator system having a wind-powered turbine according to the principles of the present disclosure;

FIG. 2 is a partially cross-sectioned, partial side view of the vehicle including the wind-powered turbine and a deployable flap in a closed position;

FIG. 3 is a partially cross-sectioned, partial side view of the vehicle with the deployable flap in an open position;

FIG. 4 is a schematic representation of components of the generator system in communication with a vehicle battery;

FIG. 5 is a partially cross-sectioned, partial side view of another vehicle having another wind-powered generator according to the principles of the present disclosure;

FIG. 6 is a side view of yet another vehicle having wind-powered generators according to the principles of the present disclosure; and

FIG. 7 is a partial top view of the vehicle and wind-powered generators of FIG. 6.

### DETAILED DESCRIPTION

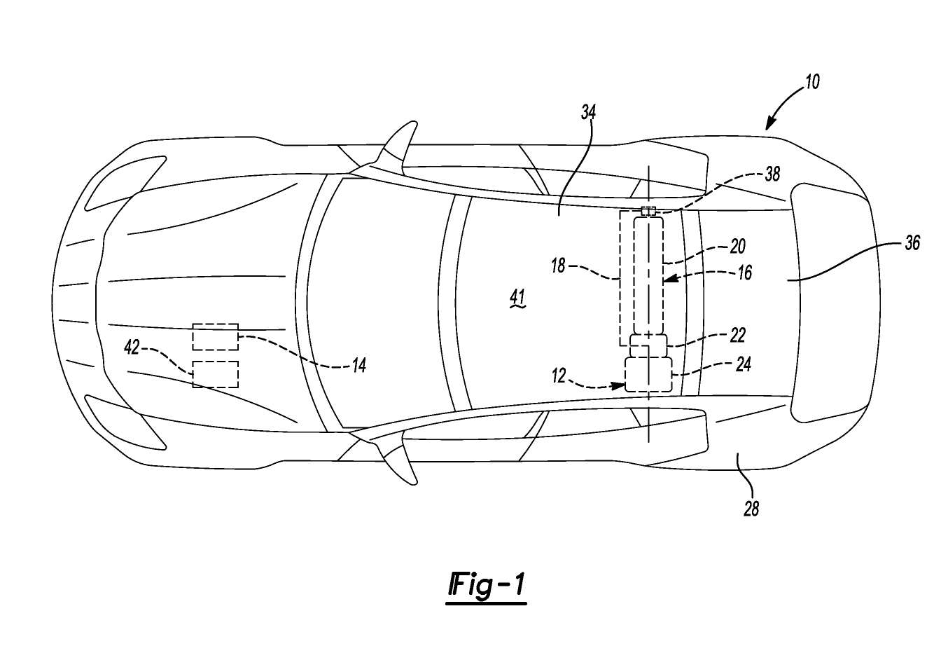

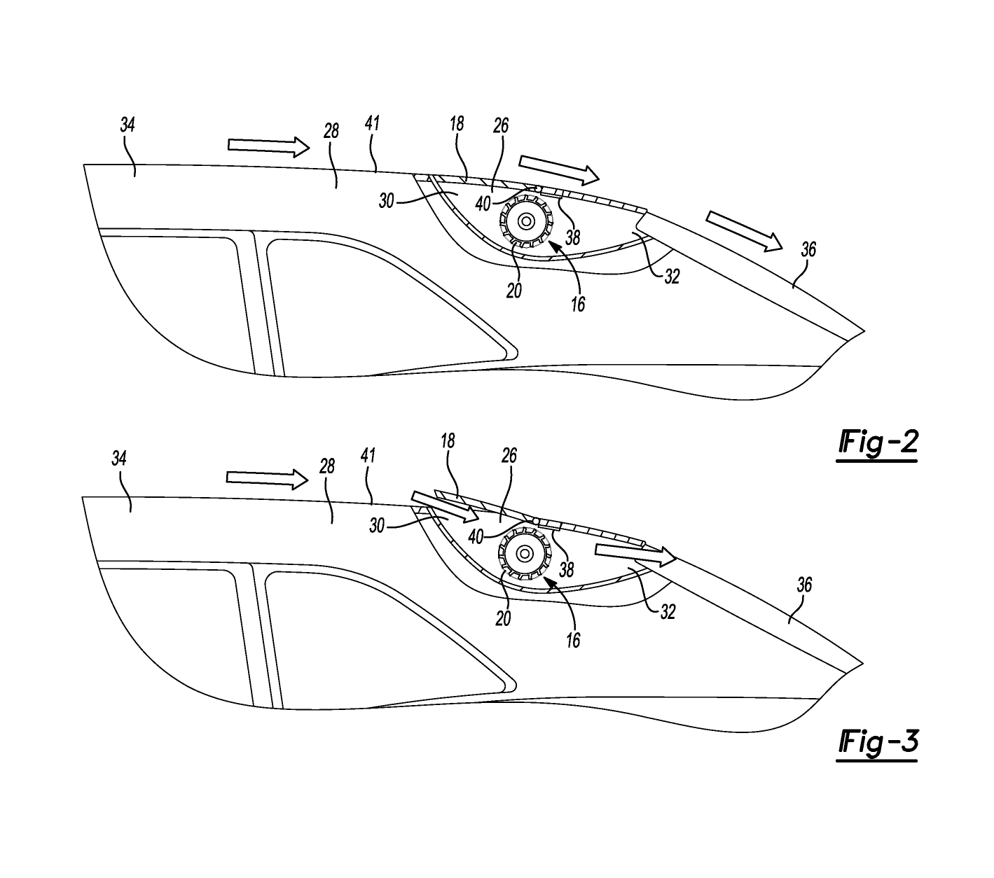

In an exemplary embodiment and with reference to FIGS. 1-4, a vehicle 10 is provided that may include a generator system 12 configured to charge or recharge one or more batteries 14 of the vehicle 10. The generator system 12 may include a wind-powered generator 16 and a deployable flap 18. While the vehicle 10 is in motion, the generator system 12 may be selectively operable to convert kinetic energy of the vehicle 10 to electrical energy to charge the one or more batteries 14. As will be subsequently described, the flap 18 may be movable between a closed position (FIG. 2) in which the wind-powered generator 16 is shielded from wind during forward motion of the vehicle 10 and an open position (FIG. 3) in which the wind-powered generator 16 is exposed to wind during forward motion of the vehicle 10. When the vehicle 10 is moving forward and the flap 18 is in the open position, wind may drive the wind-powered generator 16.

The wind-powered generator 16 may include a turbine 20, a clutch 22 and a generator 24 (as shown schematically in FIG. 1). The turbine 20 may be an axial turbine, for example, and may be disposed within a cavity 26 (FIGS. 2 and 3) in a body 28 of the vehicle 10. The cavity 26 may include an inlet 30 and an outlet 32. The turbine 20 and cavity 26 may extend horizontally across at least a portion of a width of a roof 34 of the vehicle 10. When the flap 18 is in the closed position (FIG. 2), wind may be restricted or prevented from flowing through the inlet 30 and may bypass the cavity 26. When the flap 18 is in the open position (FIG. 3), wind may flow through the inlet 30, rotate the turbine 20 and exit through the outlet 32.

While the cavity 26 is described above as being formed in the roof 34 of the vehicle 10 proximate a rear window 36 of the vehicle 10, it will be appreciated that the cavity 26 could be disposed at any other suitable location on the body 28 of the vehicle 10. The location of the cavity 26 may be chosen based on one or more of a variety of factors, such as, for example, availability of packaging space, aesthetic design considerations, and/or aerodynamic properties of the vehicle 10 (e.g., flow-separation locations, locations of high or low turbulent flow, etc.).

The clutch 22 may be any suitable type of clutch, such as a friction clutch, for example. The clutch 22 may be connected to the turbine 20 and the generator 24 and may be operable in an engaged mode to transmit rotational motion of the turbine 20 to the generator 24 and a disengaged mode that allows the turbine 20 to rotate independently of the generator 24. The generator 24 may be in electrical communication with the one or more batteries 14 and may be configured to produce electrical energy and charge the one or more batteries 14 when driven by the turbine 20. The generator 24 may be an induction generator, an alternator or any other type of generator.

The flap 18 may be moved between the open and closed positions by a flap actuator 38 (shown schematically in FIGS. 1-4). The flap actuator 38 can include any suitable type of mechanism such as a hydraulically and/or electromechanically actuated mechanism, for example. In some configurations, the flap 18 may be rotatable between the open and closed positions about a hinge 40 (shown schematically in FIGS. 2 and 3).

As shown in FIG. 2, when the flap 18 is in the closed position, all or most of the generator system 12 may be hidden from view from the outside of the vehicle 10. In the particular configuration shown, the turbine 20 may be disposed entirely below a top surface 41 of the roof 34. Therefore, when the flap 18 is closed, the generator system 12 may have little or no effect on the aesthetic styling of the vehicle 10 or the aerodynamic profile of the vehicle 10. As shown in FIG. 2, the flap 18, the cavity 26 and the rest of the generator system 12 add little or no wind resistance to the profile of the vehicle 10 when the flap is in the closed position.

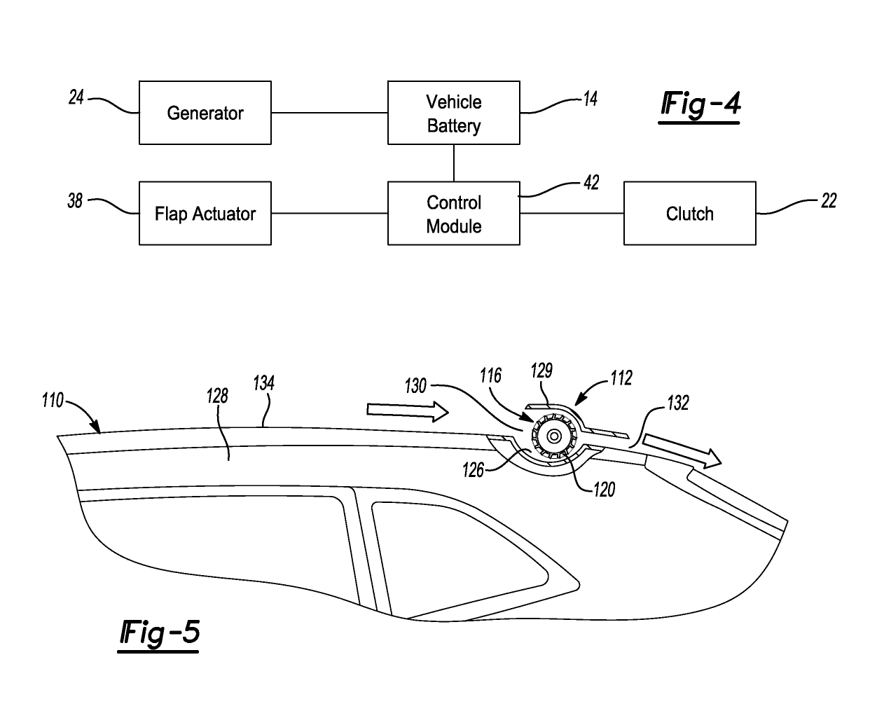

A control module 42 (FIGS. 1 and 4) may be in communication with and control operation of the clutch 22 and the flap actuator 38. The control module 42 may selectively move the clutch 22 into the engaged mode and cause the flap actuator 38 to open the flap 18 to allow the wind into the cavity 26 to drive the turbine 20 and power the generator 24. The control module 42 may include or be part of an Application Specific Integrated Circuit (ASIC), an electronic circuit, a processor (shared, dedicated or group) and/or memory (shared, dedicated or group) that execute one or more software or firmware programs, a combinational logic circuit and/or other suitable components that provide the described functionality. The control module 42 may be a part of or include a control unit controlling one or more other vehicle systems. Alternatively, the control module 42 may be a control unit dedicated to the generator system 12.

In some configurations, the control module 42 may move the clutch 22 into the engaged mode and move the flap 18 into the open position in response to a driver depressing a brake pedal of the vehicle 10. Additionally or alternatively, the control module 42 may move the clutch 22 in the engaged mode and move the flap 18 into the open position in response to the driver removing his or her foot from the accelerator pedal (i.e., the gas pedal) of the vehicle 10. In some configurations, the control module 42 may close the flap 18 when the vehicle 10 is stationary and/or traveling below a predetermined speed.

In some configurations, the control module 42 may maintain the flap 18 in the closed position when the control module 42 determines that the vehicle 10 is operating in a highway-driving mode (e.g., cruising at relatively high speed). In such configurations, the flap 18 may remain in the closed position, even if the driver has momentarily removed his or her foot from the accelerator pedal. When the control module 42 determines that the vehicle 10 is operating in a city-driving mode (e.g., the vehicle 10 is accelerating and braking relatively frequently), the control module 42 may move the clutch 22 into the engaged mode and move the flap 18 into the open position in response to removal of the driver's foot from the accelerator pedal and/or depression of the brake pedal, as described above.

In some configurations, the wind-powered generator 16 may not include the clutch 22. In such configurations, the turbine 20 may be permanently rotationally coupled to the generator 24.

With reference to FIG. 5, another vehicle 110 is provided that may include a generator system 112. The generator system 112 may include a wind-powered generator 116 that may be similar or identical to the wind-powered generator 16 described above, apart from any exceptions noted below and/or shown in the figures. The wind-powered generator 116 may include a turbine 120 coupled to a generator (not shown) by a clutch (not shown). The clutch and generator of the wind-powered generator 116 may be similar or identical to the clutch 22 and generator 24 of the wind-powered generator 16 described above.

As shown in FIG. 5, the turbine 120 may be disposed within a cavity 126 in a body 128 of the vehicle 110. The cavity 126 may be defined by a scoop 129 fixed to a roof 134 of the vehicle 110. The scoop 129 may include an inlet 130 and an outlet 132. The inlet 130 may be fixed in an open position. A control module (not shown) (which may be substantially similar to the control module 42) may control operation of the clutch according to any of the criteria described above.

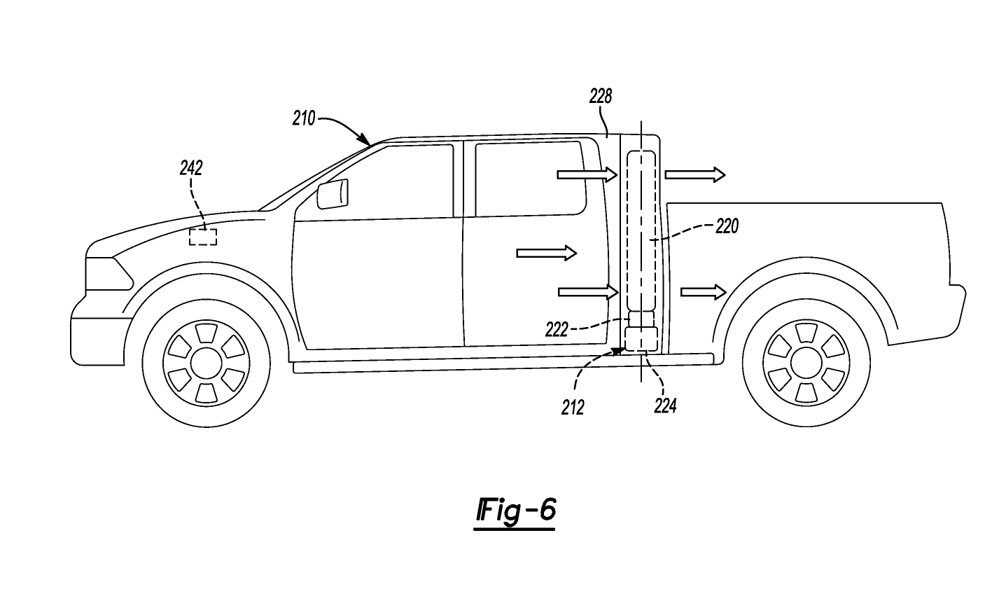

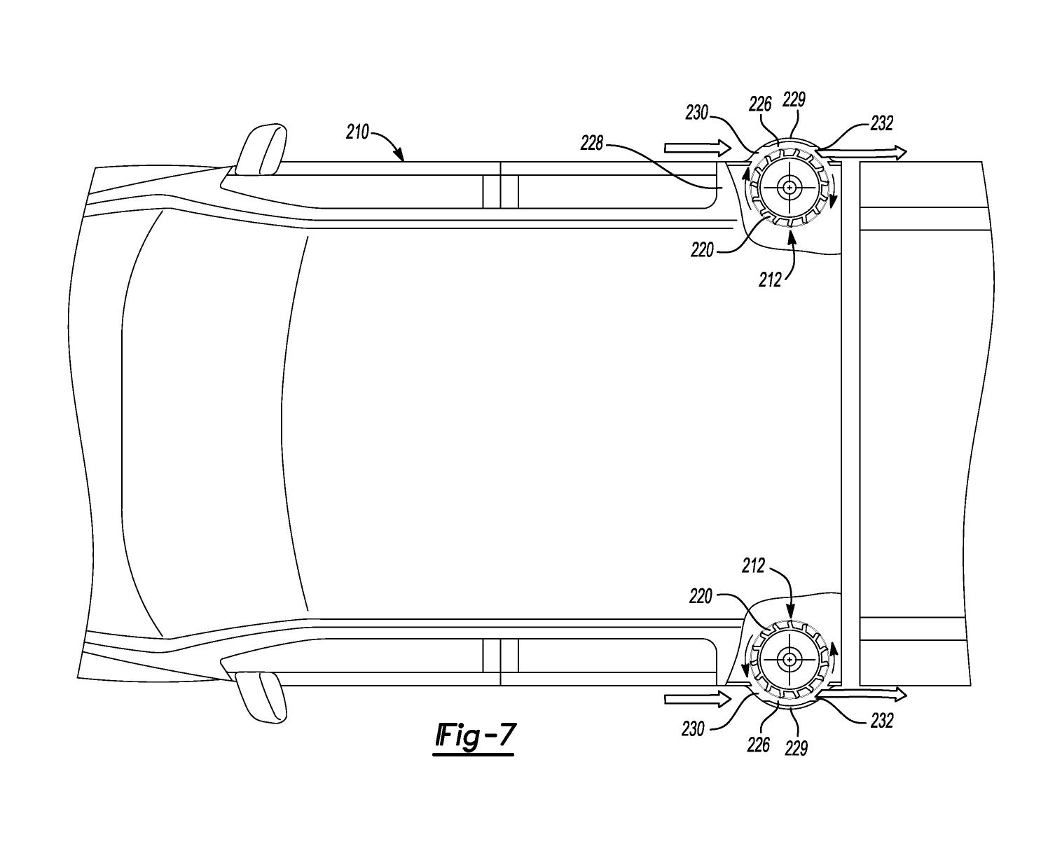

With reference to FIGS. 6 and 7, another vehicle 210 is provided that may include a plurality of generator systems 212, each having a turbine 220, a clutch 222 and a generator 224. The turbines 220, clutches 222 and generators 224 may be similar or identical to the turbine 20, clutch 22 and generator 24 described above, and therefore, will not be described again in detail.

As shown in FIG. 7, each of the turbines 220 may be disposed within a corresponding cavity 226 formed in a body 228 of the vehicle 210. In the particular configuration shown, the turbines 220 and cavities 226 may extend vertically in a location rearward of a passenger compartment of the vehicle 10. In the configuration shown in FIG. 7, the cavities 226 are partially defined by fixed scoops 229 that extend laterally outward from the body 228 and have permanently open inlets 230 and outlets 232. In some configurations, the vehicle 210 could include deployable flaps in addition to or instead of the scoops 229 that are movable to selectively allow and prevent airflow through the inlets 230. In some configurations, the deployable flaps may be substantially flush with the body 228 in the closed position and may extend laterally outward from the body 228 in the open position.

As described above, a control module 242 may control operation of the clutches 222 to selectively transmit rotational motion of the turbines 220 to the generators 224. The control module 242 may be substantially similar to the control module 42 described above and may move the clutches 222 and/or flaps between the engaged and disengaged modes according to according to any of the criteria described above.

What is claimed is:

1. A vehicle comprising:
a battery;
a generator in communication with the battery and operable to charge the battery;
a turbine mounted within a cavity formed in a body of the vehicle and rotatable relative to the body, the turbine being coupled to the generator to transmit torque from the turbine to the generator, the cavity including an inlet and an outlet; and
a member movable relative to the cavity between an open position allowing airflow through the inlet and a closed position restricting airflow through the inlet.

2. The vehicle of claim 1, wherein the cavity is formed in a roof of the body.

3. The vehicle of claim 1, wherein the member is substantially flush with a roof of the body when the member is in the closed position and extends outward from the roof in the open position.

4. The vehicle of claim 1, wherein the turbine is disposed entirely below a top surface of a roof of the body.

5. The vehicle of claim 1, further comprising an actuator operable to move the member between the open and closed positions; and a control module controlling operation of the actuator in response to deceleration of the vehicle.

6. The vehicle of claim 1, further comprising an actuator operable to move the member between the open and closed positions; and a control module controlling operation of the actuator based on whether the vehicle is in a highway-driving mode or a city-driving mode.

7. The vehicle of claim 1, further comprising a clutch coupled to the turbine and the generator and operable in an engaged mode in which rotational motion of the turbine is transmitted to the generator and a disengaged mode in which the turbine is allowed to rotate independently of the generator.

8. The vehicle of claim 7, further comprising a control module controlling operation of the clutch in response to deceleration of the vehicle.

9. The vehicle of claim 1, wherein the cavity is formed in a lateral side of the body.

10. The vehicle of claim 1, further comprising another turbine coupled to another generator and mounted within another cavity formed in the body of the vehicle.

11. A generator system for a vehicle comprising:
a generator in communication with a vehicle battery and operable to charge the vehicle battery;
a wind-powered turbine rotatably in response to exposure to airflow; and
a clutch coupled to the turbine and the generator and operable in an engaged mode to transmit torque from the turbine to the generator and a disengaged mode in which the turbine is allowed to rotate independently of the generator.

12. The generator system of claim 11, further comprising a control module controlling operation of the clutch in response to deceleration of the vehicle.

13. The generator system of claim 11, further comprising a control module controlling operation of the clutch based on whether the vehicle is in a highway-driving mode or a city-driving mode.

14. The generator system of claim 11, further comprising a scoop extending from a body of the vehicle directing air toward the turbine.

15. The generator system of claim 11, wherein the turbine is mounted within a cavity formed in a body of the vehicle and rotatable relative to the body.

16. The generator system of claim 15, further comprising a member movable relative to the cavity between an open position allowing airflow through an inlet of the cavity and a closed position restricting airflow through the inlet.

17. The generator system of claim 16, wherein the member is substantially flush with the roof when the member is in the closed position and extends outward from the roof in the open position.

18. The generator system of claim 16, further comprising an actuator operable to move the member between the open and closed positions; and a control module controlling operation of the actuator in response to deceleration of the vehicle.

19. The generator system of claim 11, wherein the turbine is disposed below a top surface of a roof of the vehicle.

20. The generator system of claim 11, wherein the turbine rotates about an axis that is perpendicular to an axis extending through front and rear ends of a body of the vehicle.
